(19) United States
(12) Patent Application Publication
(10) Pub. No.: US 2026/0097644 A1
(43) Pub. Date: Apr. 9, 2026

(54) BRACKET ASSEMBLY FOR VEHICLE FUEL FILLER ASSEMBLY

(71) Applicant: NISSAN NORTH AMERICA, INC., Franklin, TN (US)

(72) Inventors: Lizeth Patricia VITE MARAÑON, Toluca (MX); Jose Antonio DÍAZ, Mexico City (MX)

(21) Appl. No.: 18/908,103

(22) Filed: Oct. 7, 2024

(51) Int. Cl. B60K 15/04

(52) U.S. Cl. CPC B60K 15/04; B60K 2015/0474

(57) ABSTRACT

A bracket assembly for a fuel filler assembly for a vehicle includes a first bracket and a second bracket. The first bracket is configured to be connected to a panel of the vehicle. The second bracket is configured to be connected to the fuel filler assembly. The first bracket has a first end and a second end. The first end of the first bracket receives the second bracket. The second end of the first bracket is configured to be connected to a panel of the vehicle. The bracket assembly is configured to substantially prevent movement of the fuel filler assembly.

### BACKGROUND

### Technical Field

The present disclosure generally relates to a bracket assembly for a fuel filler assembly for a vehicle. More specifically, the present disclosure relates to bracket assembly for a fuel filler assembly in which a first bracket is connected to a panel of the vehicle and a second bracket is connected to the fuel filler assembly.

### Background Information

A vehicle is provided with a fuel tank to store fuel. The stored fuel is supplied to the engine to drive the vehicle. Fuel is supplied to the tank through a fuel filler assembly. The fuel filler assembly includes a fuel filler cap, a fuel filler cap protector, a grommet of a fuel filler base, and a filler tube. A fuel nozzle, or fuel gun, is inserted in the filler tube of the fuel filler assembly to supply fuel from an external fuel tank to the vehicle fuel tank. The fuel filler cap protector of the fuel filler assembly is connected to an outer panel of the vehicle. The load applied by the fuel nozzle during a refueling operation can damage the connection between the fuel cap protector and the grommet of the fuel filler base.

### SUMMARY

A need exists for a bracket assembly to substantially prevent movement of a filler tube of a fuel filler assembly of a vehicle.

In view of the state of the known technology, one aspect of the present disclosure is to provide a bracket assembly for a fuel filler assembly for a vehicle. The bracket assembly includes a first bracket and a second bracket. The first bracket is configured to be connected to a panel of the vehicle. The second bracket is configured to be connected to the fuel filler assembly. The first bracket has a first end and a second end. The first end of the first bracket receives the second bracket. The second end of the first bracket is configured to be connected to a panel of the vehicle. The bracket assembly is configured to substantially prevent movement of the fuel filler assembly.

Another aspect of the present disclosure is to provide a fuel filler assembly for a vehicle. The fuel filler assembly includes a wheel house outer panel and a first bracket assembly. The wheel house outer panel has a first opening. The fuel filler assembly is received by the first opening. The first bracket assembly is configured to substantially prevent movement of the fuel filler assembly. The first bracket assembly includes a first bracket and a second bracket. The first bracket is connected to an inboard surface of the wheel house outer panel. The second bracket is connected to the fuel filler assembly. The second bracket is received by the first bracket to substantially prevent movement of the fuel filler assembly.

Also other objects, features, aspects and advantages of the disclosed bracket assembly for a vehicle fuel filler assembly will become apparent to those skilled in the art from the following detailed description, which, taken in conjunction with the annexed drawings, discloses exemplary embodiments of the bracket assembly for a vehicle fuel filler assembly.

### BRIEF DESCRIPTION OF THE DRAWINGS

Referring now to the attached drawings which form a part of this original disclosure:

FIG. 1 is an elevational view of a vehicle equipped with the bracket assembly according to an exemplary embodiment;

FIG. 2 is a perspective view of a wheel house outer panel of the vehicle of FIG. 1;

FIG. 3 is a perspective view of a wheel house inner panel of the vehicle of FIG. 1;

FIG. 4 is a perspective view of a second bracket assembly securing a filler tube to the wheel house inner panel;

FIG. 5 is a perspective view of a filler cap connected to a filler tube of the fuel filler assembly of FIG. 5;

FIG. 6 is a perspective view of a first bracket assembly connected to a fuel filler assembly;

FIG. 7 is an enlarged perspective view of the first bracket assembly of FIG. 6;

FIG. 8 is a perspective view of a first bracket receiving a second bracket of the first bracket assembly of FIG. 7;

FIG. 9 is a perspective view of a slot in the first bracket receiving the second bracket of the first bracket assembly of FIG. 8;

FIG. 10 is a perspective view of the first bracket of the first bracket assembly of FIG. 7;

FIG. 11 is a side perspective view of the first bracket of FIG. 10;

FIG. 12 is a perspective view of the slot in the first bracket of FIG. 9; and

FIG. 13 is a perspective view of the first bracket assembly according to another exemplary embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

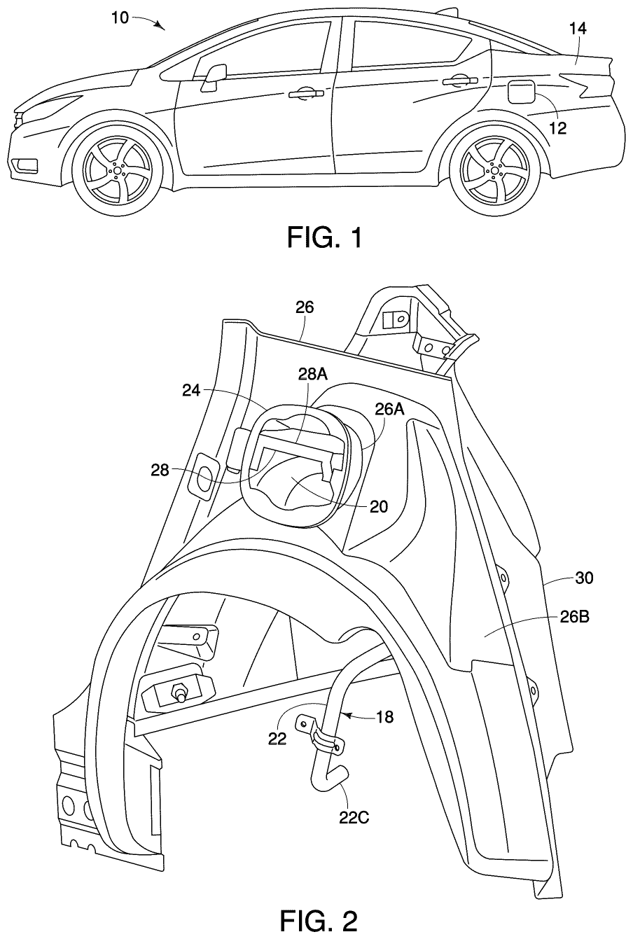

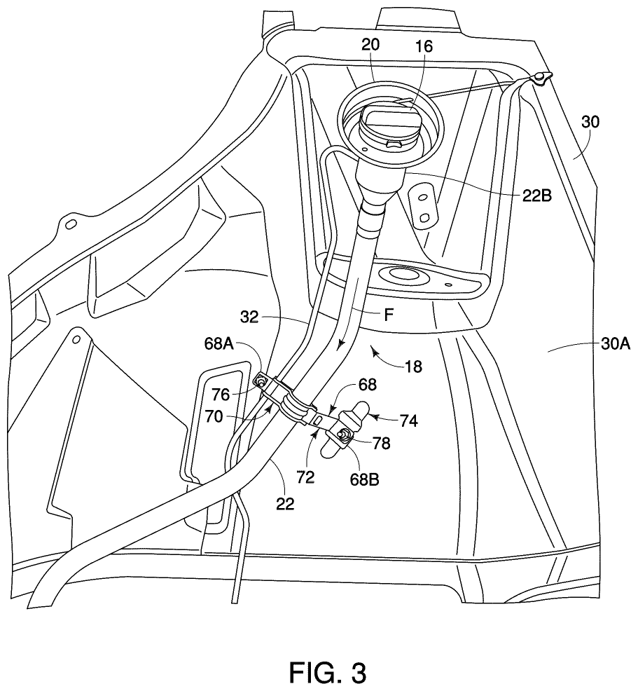

Referring initially to FIG. 1, a vehicle 10 is illustrated in accordance with an exemplary embodiment. The vehicle 10 is provided with a gas tank door 12 in a vehicle outer panel 14. Opening the fuel tank door 12 provided access to a fuel filler cap 16, as shown in FIG. 3. The fuel filler cap 16 is removed to provide access to a fuel filler assembly 18, as shown in FIGS. 2 and 3. A leash 16A is connected between the fuel filler cap 16 and the fuel filler cap protector 20 to prevent loss of the fuel filler cap 16 when removed during a refueling operation.

The fuel filler assembly 18 includes a fuel tube, or filler, cap protector 20 and a fuel tube 22, as shown in FIG. 3. The fuel tube 22 is connected to the fuel filler cap protector 20 in any suitable manner, such as by welding. The fuel filler cap 16 is received by the fuel filler cap protector 20 to seal the opening in fuel filler cap protector 20, as shown in FIGS. 3 and 5. A first end 22A of the fuel tube 22 is connected to the fuel filler cap protector 20 in a conventional manner. The first end 22A of the fuel tube 22 includes a filler neck 22B connected to the fuel filler cap protector 20. A second end 22C of the fuel tube 22 is connected to the fuel tank (not shown). The opening in the fuel filler fuel filler cap protector 20 is in fluid communication with the fuel tube 22 such that fuel is supplied to the fuel tank through the fuel filler assembly 18.

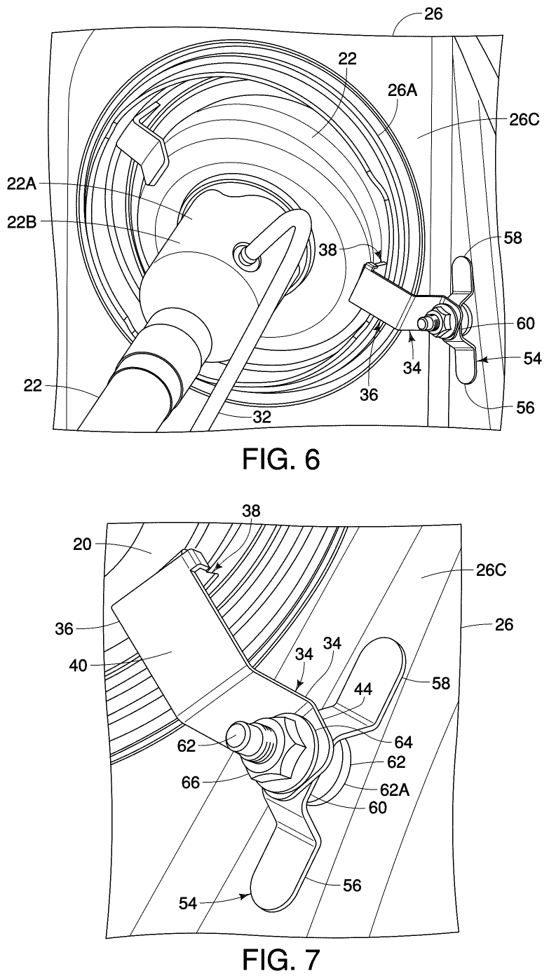

An opening 26A in the wheel house outer panel 26 receives the fuel filler assembly 18, as shown in FIGS. 2 and 6. The opening 26A in the wheel house outer panel 26 extends from an outboard surface 26B to an inboard surface 26C of the wheel house outer panel 26.

A grommet 24 surrounds the fuel filler cap protector 20, as shown in FIGS. 2 and 6. The grommet 24 is disposed between the vehicle outer panel 14 and the fuel filler cap protector 20 and between a wheel house outer panel 26 and the fuel filler cap protector 20. The grommet 24 is received by the opening 26A in the wheel house outer panel 26. The grommet 24 receives the fuel filler cap protector 20 to secure the fuel filler assembly 18 to the wheel house outer panel 26.

A support bracket 28 is connected to the fuel filler cap protector 20 to substantially prevent deflection of the fuel filler cap protector 20 during a refueling operation. An upper surface 28A of the support bracket 28 contacts the grommet to limit deflection of the fuel filler cap protector 20 during a refueling operation. A wheel house inner panel 30 is disposed on an inboard side of the wheel house outer panel 26. The wheel house inner panel 30 is connected to the wheel house outer panel 26 in a conventional manner.

A vapor return, or vent, hose 32 is connected between the fuel tank (not shown) and the first end 22A of the fuel tube 22, as shown in FIGS. 3, 4 and 6. The return hose 32 vents air from the fuel tank during a refueling operation as fuel is supplied to the tank to maintain proper pressure and vacuum levels in the fuel tank to ensure safe and efficient refueling.

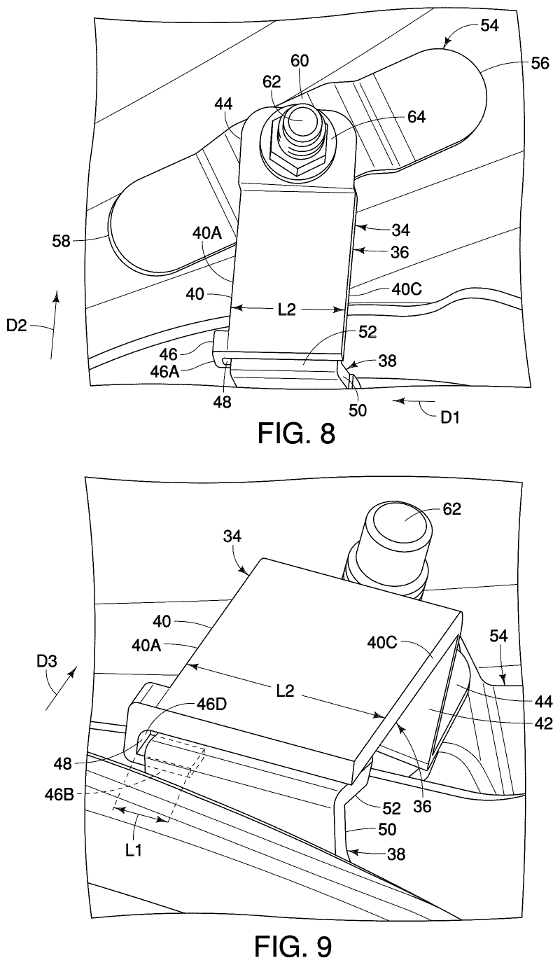

A first bracket assembly 34 is configured to substantially prevent movement of the fuel filler assembly 18, as shown in FIG. 6. The first bracket assembly 34 includes a first bracket 36 and a second bracket 38. The first bracket 36 is connected to the inboard surface 26C of the wheel house outer panel 26. The second bracket 38 is connected to the fuel filler assembly 18. The second bracket 38 is received by the first bracket 36, as shown in FIGS. 8 and 9, to substantially prevent movement of the fuel filler assembly 18.

The first bracket 36 of the first bracket assembly 34 is configured to be connected to a panel, such as the wheel house outer panel 26, of the vehicle 10, as shown in FIGS. 6-9 . The first bracket 36 has a first end 36A and a second end 36B. The first end 36A of the first bracket 36 receives the second bracket 38. The second end 36B of the first bracket 36 is configured to be connected to the panel, such as the wheel house outer panel 26, of the vehicle 10.

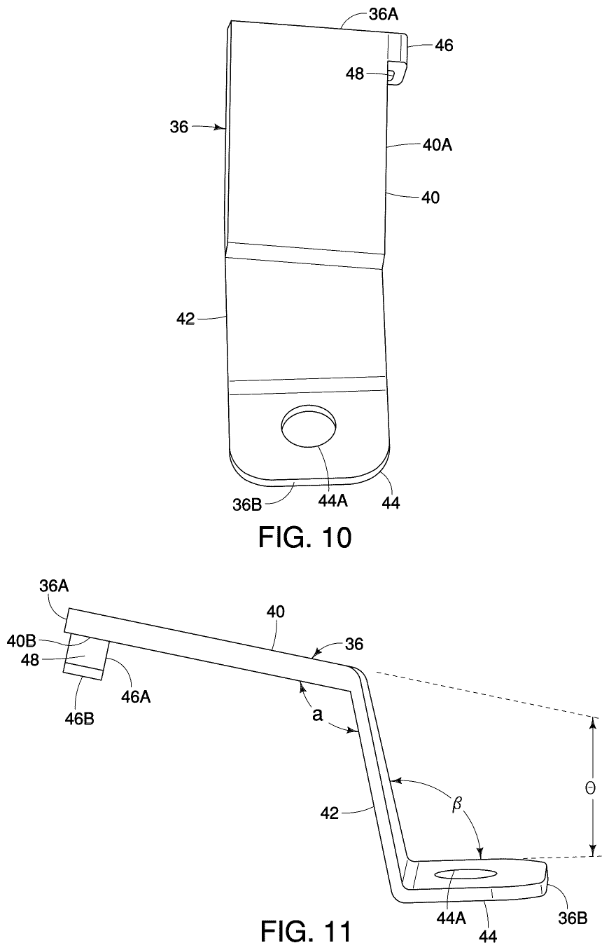

The first bracket 36 includes a first portion 40, a second portion 42 and a third portion 44, as shown in FIGS. 10-12. The second portion 42 connects the first portion 40 to the third portion 44.

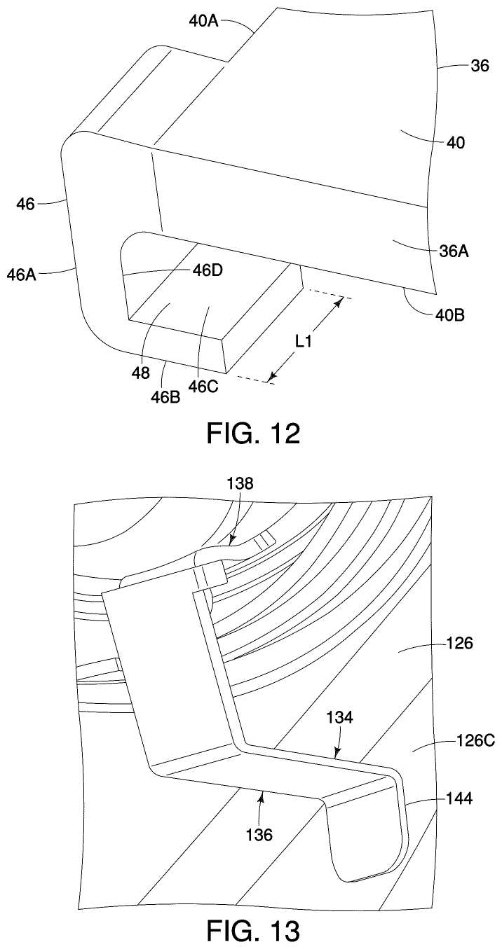

A free end 40C of the first portion 40 defines the first end 36A of the first bracket 36, as shown in FIGS. 10-12. A receiving member 46 is connected to a lateral edge 40A of the first portion 40. The receiving member 46 includes a first leg 46A connected to the lateral edge 40A of the first portion 40 of the first bracket 36. A second leg 46B extends from the first leg 46A to form a slot 48. The slot 48 is formed between an upper surface 46C of the second leg 46B of the receiving member 46 and a lower surface 40B of the first portion 40. As shown in FIGS. 8, 9 and 12, a length L1 of the slot 48 is less than a length L2. The length L1 of the slot 48 is the distance from the side surface 46C of the first leg 46A to the free end of the second leg 46B, as shown in FIGS. 9 and 12. The length L2 of the first portion 40 is the length from the first lateral edge 40A to a second lateral edge 40C, as shown in FIGS. 8 and 9. The first length L1 is measured in a direction substantially parallel to the second length L2. The slot 48 is defined by an upper surface 46C of the second leg 46B, a lower surface 40B of the first portion 40, and a side surface 46D of the first leg 46A extending between the upper surface 46C and the lower surface 40B. The slot 48 is formed at the first end 36A of the first bracket 36 and is configured to receive the second bracket 38.

The second portion 42 of the first bracket 36 extends from the first portion 40, as shown in FIGS. 9-11. An angle α is formed between the first portion 40 and the second portion 42, as shown in FIG. 11. The angle α is preferably larger than 90 degrees. More preferably, the angle α is between approximately 110 and 130 degrees, inclusive. More preferably, the angle α is approximately 122.8 degrees.

The third portion 44 of the first bracket 36 extends from the second portion 42, as shown in FIGS. 9-11. An angle β is formed between the second portion 42 and the third portion 44, as shown in FIG. 11. The angle β is preferably larger than 90 degrees. More preferably, the angle β is between approximately 90 and 120 degrees, inclusive. More preferably, the angle β is approximately 106.9 degrees. A fastener opening 44A is disposed in the third portion 44 of the first bracket 36.

An angle θ is formed between virtual extensions of the first portion 40 and the third portion 44, as shown in FIG. 11. The angle θ is preferably smaller than 30 degrees. More preferably, the angle θ is between approximately 10 and 30 degrees, inclusive. More preferably, the angle θ is approximately 15.9 degrees.

The first bracket 36 is preferably integrally formed as a one-piece member. The first bracket 36 is preferably made of a metallic material, such as, but not limited to, galvanized steel.

The second bracket 38 of the first bracket assembly 34 is configured to be connected to the fuel filler assembly 18, as shown in FIGS. 5-9. The second bracket 38 includes a first portion 50 and a second portion 52. The first portion 50 of the second bracket 38 is configured to be connected to the fuel filler assembly 18. The second portion 52 of the second bracket 38 is configured to be received by the first bracket 36. The second portion 52 is angularly disposed relative to the first portion 50. The second portion 52 preferably extends substantially perpendicularly from the first portion 50, as shown in FIG. 5.

As shown in FIG. 5, the first portion 50 is connected to the fuel filler cap protector 20 of the fuel filler assembly 18. The first portion 50 is connected to the fuel filler cap protector 20 in any suitable manner, such as by welding.

The second portion 52 of the second bracket 38 is configured to be received by the first bracket 36, as shown in FIGS. 8 and 9. The second portion 52 of the second bracket 38 is received by the slot 48 in the first bracket 36.

The second bracket 38 is preferably integrally formed as a one-piece member. The second bracket 38 is preferably made of a metallic material, such as, but not limited to, stainless steel.

The first bracket assembly 34 includes a third bracket 54, as shown in FIGS. 6-9. The third bracket 54 includes a first leg 56 and a second leg 58 connected by a connecting portion 60. The first leg 56 and the second leg 58 are connected to the inboard surface 26C of the wheel house outer panel 26. The first and second legs 56 and 58 of the third bracket 54 are connected to the inboard surface 26C of the wheel house outer panel 26 in any suitable manner, such as by welding. The connecting portion 60 forms an arch between the first and second legs 56 and 58 of the third bracket 54. In other words, the connecting portion 60 is spaced from the inboard surface 26C of the wheel house outer panel 26.

As shown in FIGS. 6 and 8, the connecting portion 60 of the third bracket 54 includes a fastener opening configured to receive a fastener 62. The fastener opening in the third bracket 54 is configured to be aligned with the fastener opening 44A in the third portion 44 of the first bracket 36 to connect the second end 36B of the first bracket to the wheel house outer panel 26. In other words, the third bracket 54 is configured to be connected between the second end 36B of the first bracket 36 and the vehicle panel, such as the wheel house outer panel 26.

The fastener 62 secures the third bracket 54 to the first bracket 36, as shown in FIGS. 6-9. The fastener 62 is inserted through the connecting portion 60 of the third bracket and the third portion 44 of the first bracket 36 such that a fastener head 62A of the fastener 62 is disposed between the connecting portion 60 of the third bracket 54 and the inboard surface 26C of the wheel house outer panel 26. A washer 64 can be disposed between the third portion 44 of the first bracket 36 and a nut 66 disposed on the fastener 62. The third portion 44 of the first bracket 36 is disposed between the connecting portion 60 of the third bracket 54 and the washer 64. The second end 36B of the first bracket 36 is configured to be spaced from the vehicle panel, such as the wheel house outer panel 26, in an axial direction of the fastener 62, as shown in FIG. 7.

To assemble the first bracket assembly 34, the second bracket 38 is connected to the fuel filler cap protector 20 of the fuel filler assembly 18 in any suitable manner, such as by welding, as shown in FIG. 5. The first bracket 36 is then connected to the second bracket 38, as shown in FIGS. 6-9. The first bracket 36 is positioned such that the slot 48 in the connecting portion 46 receives the second portion 52 of the second bracket 38. As shown in FIG. 8, the slot 48 surrounds three sides of the second portion 52 of the second bracket 38. The slot 48 surrounds an upper surface, a lower surface and one side surface of the second portion 52 of the second bracket 38. The side surface of the second portion 52 opposite the insertion direction remains exposed.

The third portion 44 of the first bracket 36 is then connected to the connecting portion 60 of the third bracket 56, as shown in FIGS. 6-9. The fastener 62 is then inserted from the panel side of the connecting portion 60 through the connecting portion 62 of the third bracket 54 and through the third portion 44 of the first bracket 36. A washer 64 and nut 66 are then disposed on the fastener 62 such that the third portion 44 is disposed between the connecting portion 60 of the third bracket 54 and the washer 64. The first and second legs 56 and 58 of the third bracket 54 are then connected to the inboard surface 26C of the wheel house outer panel 26 in any suitable manner, such as by welding. The third bracket 56 is preferably not perpendicularly disposed relative to the first bracket 36, as shown in FIG. 8.

Movement of the fuel filler cap protector 20 of the fuel filler system 18 is substantially prevented in a first direction D1, as shown in FIG. 8, by contact between the second portion 52 of the second bracket 38 and the receiving member 46 of the first bracket 36. The direction D1 is in a direction through the slot 48 toward the first leg 46A of the receiving member 46.

Movement of the fuel filler cap protector 20 of the fuel filler system 18 is substantially prevented in a second direction D2, as shown in FIG. 8, by the contact between the first portion 50 of the second bracket 38 and the receiving member 46 of the first bracket 36. The direction D2 is a direction through the slot 48 toward the third bracket 54.

Movement of the fuel filler cap protector 20 of the fuel filler system 18 is substantially prevented in a third direction D3, as shown in FIG. 9, by contact between the second portion 52 of the second bracket 38 and the first portion 40 of the first bracket 36. The direction D3 is a direction through the slot toward the first portion 40 of the first bracket 36 and away from the second leg 46B of the receiving member 46.

The first bracket assembly 34 substantially prevents movement of the fuel filler cap protector 20 of the fuel filler system 18 in three directions such that deterioration of the connection between the fuel filler cap protector 20 and the fuel tube 22 is substantially prevented. Each of the directions D1, D2 and D3 is substantially perpendicular to the other two directions.

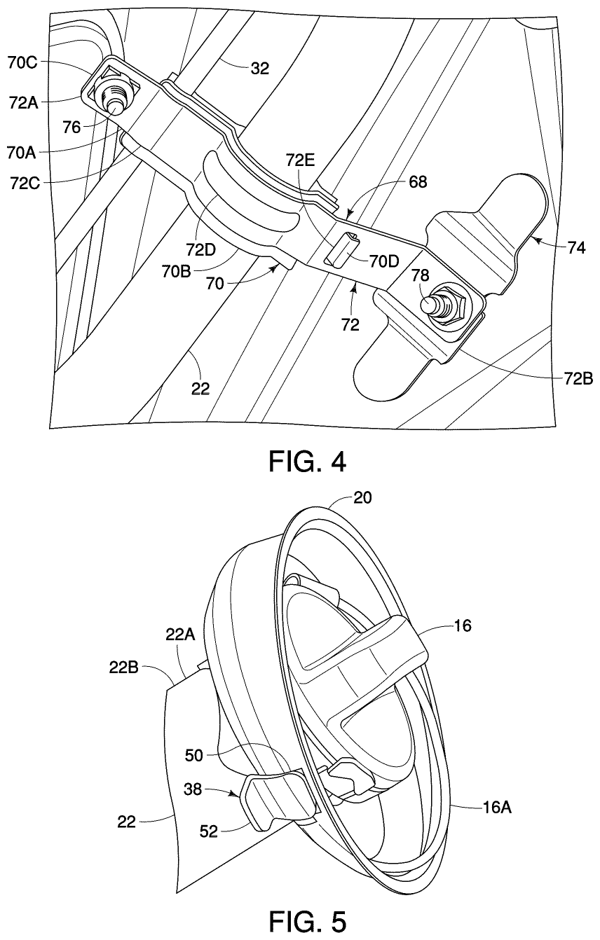

A second bracket assembly 68, as shown in FIGS. 3 and 4, secures the fuel tube 22 and the vapor return hose 32 to an outboard surface 30A of the wheel house inner panel 30. The second bracket assembly 68 is connected to the wheel house inner panel 30. The second bracket assembly 68 secures the fuel tube 22 and the vapor return hose 32 to the wheel house inner panel 30. The second bracket assembly 68 is secured to the outboard surface 30A of the wheel house inner panel 30. The second bracket assembly 68 substantially prevents movement of the fuel tube 22 and the return vapor hose 32 to further facilitate preventing deterioration of the connection between the fuel filler cap protector 20 and the fuel tube 22. The second bracket assembly 68 is disposed downstream of the first bracket assembly 34 in a flow direction F of the fuel through the filler tube 22.

The second bracket assembly 68 includes a first bracket 70, a second bracket 72 and a third bracket 74, as shown in FIGS. 3 and 4.

A first end 68A of the second bracket assembly 68 is secured by a fastener 76 to the outboard surface 30A of the wheel house inner panel 30, as shown in FIG. 3. A second end 68B of the second bracket assembly 68 is secured by a fastener 78 to the outboard surface 30A of the wheel house inner panel 30. A first curved portion of the second bracket assembly secures the fuel tube 22 to the outboard surface 30A of the wheel house inner panel 30. A second curved portion of the second bracket assembly secures the vapor return hose 32 to the outboard surface 30A of the wheel house inner panel 30. The first and second curved portions of the second bracket assembly are disposed between the first and second ends 68A and 68B of the second bracket assembly 68.

The first bracket 70 of the second bracket assembly 68 includes a first curved portion 70A and a second curved portion 70B to accommodate the return vapor hose 32 and the fuel tube 22, respectively. A first end 70C of the first bracket 70 is secured to the outboard surface of the wheel house inner panel 30. A hook is formed at a second end 70D of the first bracket 70.

The second bracket 72 includes a first end 72A and a second end 72B, as shown in FIGS. 3 and 4. The second bracket 72 overlies the first bracket 70. The first end 72A overlies the first end 70C of the first bracket 70. A fastener 76 passes through the first ends 70C and 72A of the first and second brackets 70 and 72. The second bracket 72 includes a first curved portion 72C and a second curved portion 72D to accommodate the return vapor hose 32 and the fuel tube 22, respectively. An opening 72E in the second bracket 72 receives the hook formed at the second end 70D of the first bracket 70.

A third bracket 74 is connected to the outboard surface 30A of the wheel house inner panel 30 in any suitable manner, such as by welding, as shown in FIGS. 3 and 4. The second end 72B of the second bracket 72 is connected to the third bracket 74 by a fastener. A fastener 78 secures the second bracket 72 to the third bracket 74.

Another exemplary embodiment of the first bracket assembly 134 for a vehicle fuel filler system is shown in FIG. 13. The features of the first bracket assembly 134 of FIG. 13 that are substantially similar to the features of the first bracket assembly 34 of FIGS. 1-12 are provided the same reference numerals as the features of the first bracket assembly 34 except in the 100 series (i.e., 1xx). Moreover, the descriptions of the parts of the first bracket assembly of FIG. 13 that are identical to the first bracket assembly of FIGS. 1-12 are omitted for the sake of brevity.

The first bracket assembly 134 eliminates the third bracket 54 of the first bracket assembly 34 of FIGS. 1-12. The third portion 144 of the third bracket 134 is directly connected to the inboard surface 126C of the wheel house outer panel 126, as shown in FIG. 13, in any suitable manner, such as by welding. The remaining features of the first bracket 136 and the second bracket 138 of the first bracket assembly 134 are substantially similar to the features of the first bracket 36 and the second bracket 38 of the first bracket assembly 34 of FIGS. 1-12.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the bracket assembly for a vehicle fuel filler system. Accordingly, these terms, as utilized to describe the present invention should be interpreted relative to a vehicle equipped with the bracket assembly for a vehicle fuel filler system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A bracket assembly for a fuel filler assembly for a vehicle, the bracket assembly comprising:
a first bracket configured to be connected to a panel of the vehicle; and
a second bracket configured to be connected to a fuel filler cap protector of the fuel filler assembly,
the first bracket having a first end and a second end, the first end of the first bracket receiving the second bracket, the second end of the first bracket being configured to be connected to a panel of the vehicle, the bracket assembly being configured to substantially prevent movement of the fuel filler assembly.

2. The bracket assembly according to claim 1, wherein
a slot is formed at the first end of the first bracket, the second bracket being received by the slot.

3. The bracket assembly according to claim 2, wherein
the second bracket has a first portion configured to be connected to the fuel filler assembly, and a second portion extending substantially perpendicularly from the first portion.

4. The bracket assembly according to claim 3, wherein
the second portion of the second bracket is received by the slot in the first bracket.

5. The bracket assembly according to claim 4, wherein
the slot is defined by an upper surface, a lower surface, and a side surface extending between the upper surface and the lower surface.

6. The bracket assembly according to claim 5, wherein
the slot surrounds three sides of the second portion of the second bracket.

7. The bracket assembly according to claim 1, wherein
a third bracket is configured to be connected between the second end of the first bracket and the vehicle panel.

8. The bracket assembly according to claim 7, wherein
a fastener secures the third bracket to the first bracket.

9. The bracket assembly according to claim 8, wherein
the second end of the first bracket is configured to be spaced from the vehicle panel in an axial direction of the fastener.

10. A fuel filler assembly for a vehicle, the fuel filler assembly comprising:
a wheel house outer panel having a first opening, the fuel filler assembly being received by the first opening; and
a first bracket assembly configured to substantially prevent movement of the fuel filler assembly, the first bracket assembly including
a first bracket connected to an inboard surface of the wheel house outer panel; and
a second bracket connected to a fuel filler cap protector of the fuel filler assembly;
the second bracket being received by the first bracket to substantially prevent movement of the fuel filler assembly.

11. The fuel filler assembly according to claim 10, wherein
the first bracket has a first end and a second end, the first end of the first bracket being received by the second bracket, the second end of the first bracket being connected to the wheel house outer panel.

12. The fuel filler assembly according to claim 11, wherein
a slot is formed at the first end of the first bracket, the second bracket being received by the slot.

13. The fuel filler assembly according to claim 12, wherein
the second bracket has a first portion connected to the fuel filler assembly, and a second portion extending substantially perpendicularly from the first portion.

14. The fuel filler assembly according to claim 13, wherein
the second portion of the second bracket is received by the slot in the first bracket.

15. The fuel filler assembly according to claim 14, wherein
the slot is defined by an upper surface, a lower surface, and a side surface extending between the upper surface and the lower surface.

16. The bracket assembly according to claim 15, wherein
the slot surrounds three sides of the second portion of the second bracket.

17. The fuel filler assembly according to claim 10, wherein
a third bracket is configured to be connected between the second end of the first bracket and the vehicle panel.

18. The fuel filler assembly according to claim 17, wherein
a fastener secures the third bracket to the first bracket, the second end of the first bracket being spaced from the vehicle panel in an axial direction of the fastener.

19. The fuel filler assembly according to claim 10, wherein
a second bracket assembly connected to a wheel house inner panel, the second bracket assembly securing a fuel tube and a vapor return hose to the wheel house inner panel.

20. The fuel filler assembly according to claim 19, wherein
the second bracket assembly is connected to an outboard surface of the wheel house inner panel.
